(19) United States
(12) Patent Application Publication
(10) Pub. No.: US 2012/0319328 A1
(43) Pub. Date: Dec. 20, 2012

(54) TABLET MANUFACTURING METHOD

(75) Inventors: Shinji Ando, Tokyo (JP); Kenji Yoshida, Tokyo (JP); Takuji Ueda, Tokyo (JP)

(73) Assignee: TAISHO PHARMACEUTICAL CO., LTD., Tokyo (JP)

(21) Appl. No.: 13/582,395

(22) PCT Filed: Mar. 3, 2011
(86) PCT No.: PCT/JP2011/054927

§ 371 Date: Aug. 31, 2012

(30) Foreign Application Priority Data
Mar. 5, 2010 (JP) 2010-049808

(51) Int. Cl. B29C 43/02

(52) U.S. Cl. 264/319

(57) ABSTRACT

An object is to provide a tablet manufacturing method which may restrain formation of a tablet edge surface and permits less effect of intra-tablet stress developed in process of press-forming on a tablet quality in cases where an upper rod and a lower rod are fittingly inserted into a vertical hole formed in a die to press powder in the die hole with a pushing surface at the lower end of the upper rod and a pushing surface at the upper end of the lower rod in order to press-form a tablet.

Disclosed is a tablet manufacturing method in which an upper rod 3 and a lower rod 4 are fittingly inserted into a vertical hole 2 formed in a die 1 to press powder 5 in the die hole 2 with a pushing surface 9a at the lower end of the upper rod 3 and a pushing surface 11a at the upper end of the lower rod 4 in order to press-form a tablet 6, characterized in that concave forming grooves 2a integrally linked to the upper and lower pushing surfaces 9a and 11a are formed annularly in the inner circumferential surface of the die hole 2, and the die may be divided into an upper separable piece 7 and a lower separable piece 8 at the bottom portions of the forming grooves 2a, wherein after a final fixed rod or one of the upper and lower rods 3 and 4 is moved to and then fixed at a press-forming position at which the pushing surface 9a or 11a is integrally linked to the corresponding forming groove 2a, a final pressing rod or the other rod 3 or 4 is moved to the press-forming position so that the tablet 6 of a circular, elliptical or oval form as viewed in cross sectional side is press-formed, and then, the press-formed tablet 6 held in the forming grooves 2a is taken out of the die by separating the upper and lower separable pieces 7 and 8, in which case, the tablet 6 after being taken out of a final fixed separable piece or the separable piece 7 or 8 adjacent to the final fixed rod and also out of the final fixed rod is taken out of a final pressing separable piece or the separable piece 7 or 8 adjacent to the final pressing rod.

### TECHNICAL FIELD

This invention relates to a tablet manufacturing method in which a tablet is press-formed using a tablet press or the like.

### BACKGROUND ARTS

There is one known tablet manufacturing method as disclosed in a Patent document 1, in which a tablet is press-formed using a tablet press in such a manner that an upper rod and a lower rod are fittingly inserted into a vertical hole formed in a die to press powder in the die hole with a pushing surface at the lower end of the upper rod and a pushing surface at the upper end of the lower rod in order to press-form the tablet.

Meanwhile, it is considered that stress remains in the thus press-formed tablet, and intra-tablet stress developed at the tablet surface adjacent to the inner circumferential surface of the die hole is called residual wall stress in particular. It is known that the stress such as the residual wall stress may cause an obstacle to tablet pressing, such as capping which is exfoliation of a tablet surface, in the case of application of a release process of drawing the upper rod or the lower rod out of the die hole and/or an ejecting process of taking out the thus press-formed tablet thereafter. In a Non-Patent document 1, there is disclosed one technology which is such that machining is given to increase the plastic deformation of powder and/or to decrease the frictional coefficient in order to prevent such poor conditions.

### LITERATURES ON PRIOR ARTS

### Patent Document

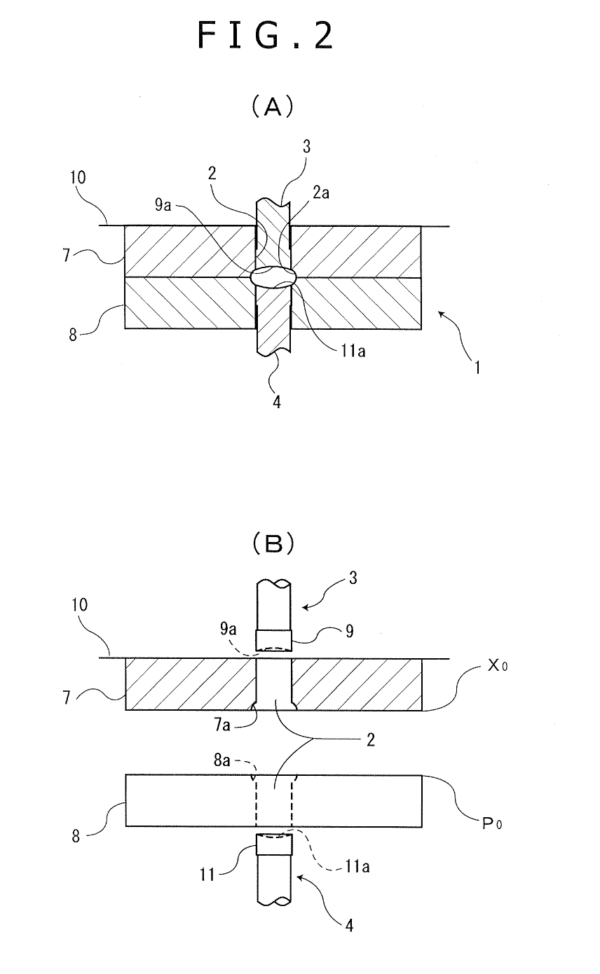

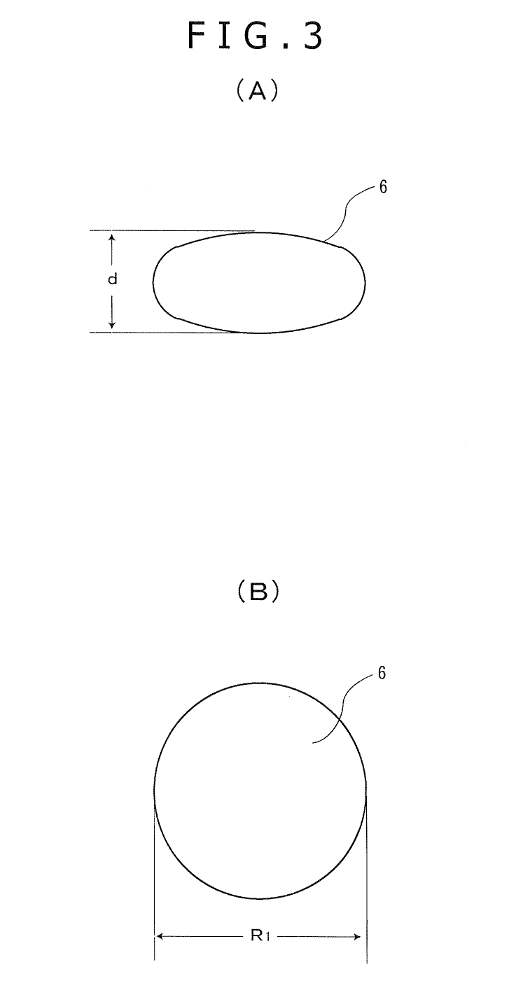

Patent document 1: Japanese Patent Laid-open Publication No. Hei 7-8540 (FIGS. 2 and 3)

### Non-Patent Document

Non-Patent document 1: “Powder Press-forming Technology” edited by the Society of Powder Technology, Japan/Division of Particulate Design and Preparations and issued by Business & Technology Daily News, Jun. 30, 1998, pp. 75 to 81

### SUMMARY OF THE INVENTION

### Problems to be Solved by the Invention

For the tablet manufacturing method described in the above Patent document 1, the arrangement is such that the die hole is formed in a vertical direction with respect to the horizontal pushing surfaces, and it will thus result in that the press-formed tablet having an edge (irregularities) surface be formed due to the connection ends of the circumferential surface of the die hole and the pushing surfaces. The thus formed tablet edge surface is relatively easy to be so chipped as to cause the defects in products in some cases, and besides, involves a problem which is such that when the tablet edge surface is covered with sugar coating, the sugar-coated tablet increases the size as compared with the tablet previous to sugar coating.

Meanwhile, for the above Non-Patent document 1, the effect of the residual wall stress or the intra-tablet stress developed at the tablet surface adjacent to the inner circumferential surface of the die hole in process of press-forming is supposed to vary with release means of releasing the press-formed tablet from pressed and/or taking-out means of taking the tablet out of the die hole. For that reason, even if the plastic deformation factor of the powder and/or the frictional coefficient of the die hole is varied, it will result in that how the above release means and/or the above taking-out means or the like should be arranged remains a root problem.

An object of the present invention is to provide a tablet manufacturing method, which may restrain formation of a tablet edge surface and permits less effect of intra-tablet stress developed in process of press-forming on a tablet quality in cases where an upper rod and a lower rod are fittingly inserted into a vertical hole formed in a die to press powder in the die hole with a pushing surface at the lower end of the upper rod and a pushing surface at the upper end of the lower rod in order to press-form a tablet.

### Means for Solving the Problems

To solve the above problems, the present invention firstly provides a tablet manufacturing method in which an upper rod 3 and a lower rod 4 are fittingly inserted into a vertical hole 2 formed in a die 1 to press powder 5 in the die hole 2 with a pushing surface 9a at the lower end of the upper ponder 3 and a pushing surface 11a at the upper end of the lower rod 4 in order to press-form a tablet 6, characterized in that concave forming grooves 2a integrally linked to the upper and lower pushing surfaces 9a and 11a are formed annularly in the inner circumferential surface of the die hole 2, and the die may be divided into an upper separable piece 7 and a lower separable piece 8 at the bottom portions of the forming grooves 2a, wherein after a final fixed rod or one of the upper and lower rods 3 and 4 is moved to and then fixed at a press-forming position at which the pushing surface 9a or 11a is integrally linked to the corresponding forming groove 2a, a final pressing rod or the other rod 3 or 4 is moved to the press-forming position so that the tablet 6 of a circular, elliptical or oval form as viewed in cross sectional side is press-formed, and then, the press-formed tablet 6 held in the forming grooves 2a is taken out of the die by separating the upper and lower separable pieces 7 and 8, in which case, the tablet 6 after being taken out of a final fixed separable piece or the separable piece 7 or 8 adjacent to the final fixed rod and also out of the final fixed rod is taken out of a final pressing separable piece or the separable piece 7 or 8 adjacent to the final pressing rod.

Secondly, there is provided the tablet manufacturing method wherein the final fixed rod or the final fixed separable piece is displaced so that the final fixed rod will be out of position nearer to the final pressing rod with respect to the final fixed separable piece in order to take the tablet 6 out of the final fixed separable piece, and the final fixed ponder or the final pressing rod is displaced so that the final fixed rod and the final pressing rod will get away from each other in order to take the tablet 6 out of the final fixed rod.

Thirdly, there is provided the tablet manufacturing method wherein a separating action of the final pressing rod and the final pressing separable piece from the final fixed separable piece at the same velocity is started at the same time as a moving action of the final fixed rod toward the final pressing rod, in which case, a separating velocity at the time of the above separating action of the final pressing rod and the final pressing separable piece is set at a value higher than a moving velocity at the time of the above moving action of the final fixed rod in order to take the tablet 6 out of the final fixed separable piece and the final fixed rod.

Fourthly, there is provided the tablet manufacturing method wherein the lower rod 4 is regarded as the final pressing rod, and the lower separable piece 8 is regarded as the final pressing rod.

Fifthly, there is provided the tablet manufacturing method wherein a separating action of the final fixed separable piece from the final pressing separable piece is started at the same time as a moving action of the final fixed rod in the direction away from the final pressing rod, in which case, a moving velocity at the time of the above moving action of the final fixed rod is set at a value lower than a separating velocity at the time of the above separating action of the final fixed separable piece in order to take the tablet 6 out of the final fixed separable piece and the final fixed rod.

Sixthly, there is provided the tablet manufacturing method wherein the upper rod 3 is regarded as the final pressing rod, and the upper separable piece 7 is regarded as the final pressing separable piece.

### EFFECTS OF THE INVENTION

According to the present invention of the above arrangements, it will be appreciated that the concave forming grooves formed in the inner circumferential surface of the die hole are integrally linked to the upper and lower pushing surfaces into a circular, elliptical or oval form as viewed in cross sectional side at the time when the tablet is press-formed, so that formation of the tablet edge surface may be efficiently prevented in process of press-forming. It will be appreciated also that the die may be divided into the upper and lower separable pieces at the bottom portions of the forming grooves, so that there may be provided a larger diameter than an open-end diameter of the die hole, which arrangement thus allows the press-formed tablet held in the forming grooves to be taken out of the die.

It will be appreciated also that thanks to the forming grooves and the upper and lower separable pieces, release of the tablet from pressed with the upper and lower rods and/or ejection of the tablet from the die hole or like action takes a process different from that in the prior art, and therefore, it may be expected that there will be the peculiar effect of the intra-tablet stress developed in process of press-forming. However, the press-formed tablet held in the forming grooves may be taken out by separating the upper and lower separable pieces, in which case, the tablet after being taken out of the final fixed separable piece and subsequently out of the final fixed rod may be taken out of the final pressing separable piece, so that efficient release from the intra-tablet stress developed in process of press-forming may be attained, which arrangement thus allows the effect of the intra-tablet stress developed in process of press-forming to be minimized.

It will be appreciated also that if the separating action of the final pressing rod and the final pressing separable piece from the final fixed separable piece at the same velocity is started at the same time as the moving action of the final fixed rod toward the final pressing rod, in which case, the separating velocity at the time of the above separating action of the final pressing rod and the final pressing separable piece is set at the value higher than the moving velocity at the time of the above moving action of the final fixed rod in order to take the tablet out of the final fixed separable piece and the final fixed rod, or alternatively, the separating action of the final fixed separable piece from the final pressing separable piece is started at the same time as the moving action of the final fixed rod in the direction away from the final pressing rod, in which case, the moving velocity at the time of the above moving action of the final fixed rod is set at the value lower than the separating velocity at the time of the above separating action of the final fixed separable piece in order to take the tablet out of the final fixed separable piece and the final fixed rod, it would be possible to start at the same time two actions in such a manner as to provide a difference in velocity in order to allow the tablet having been taken out of the final fixed separable piece to be thereafter speedily taken out of the final fixed rod, so that more efficient release from the intra-tablet stress developed in process of press-forming may be attained, which arrangement thus allows higher quality tablets to be manufactured.

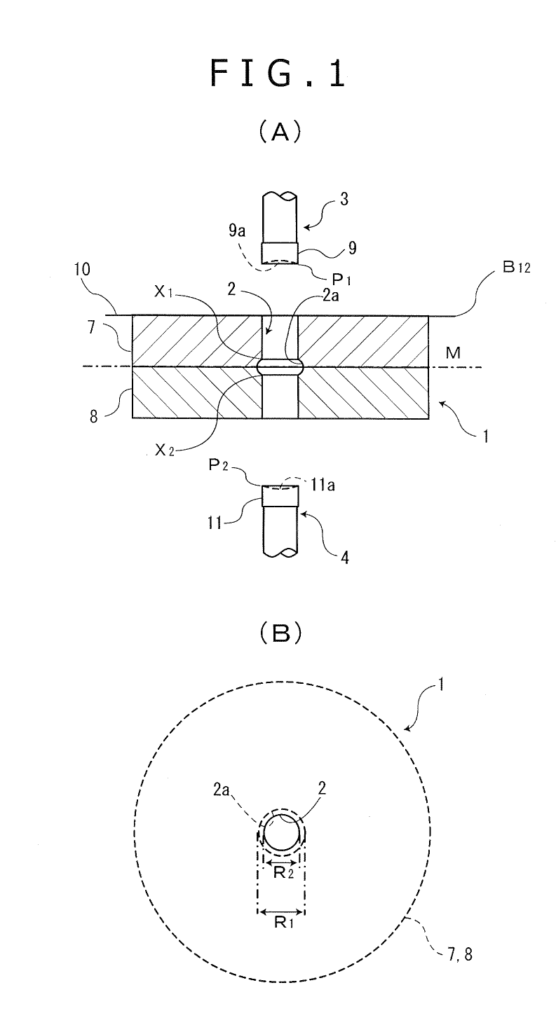

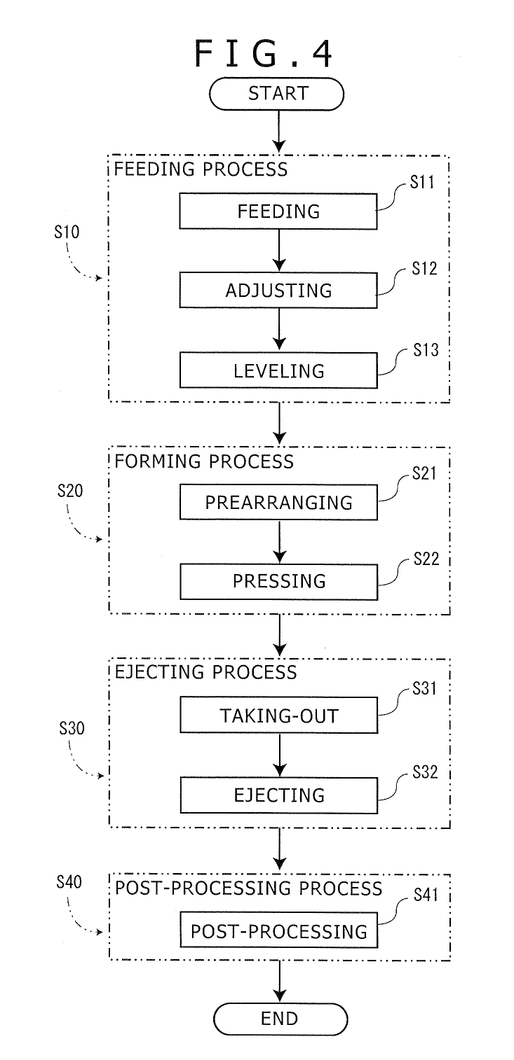

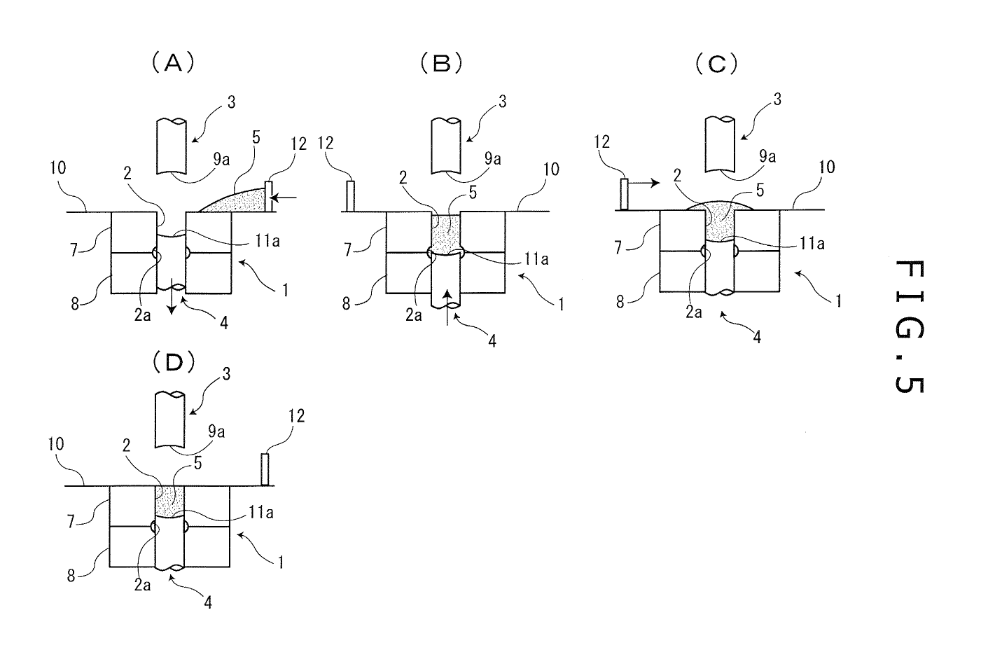

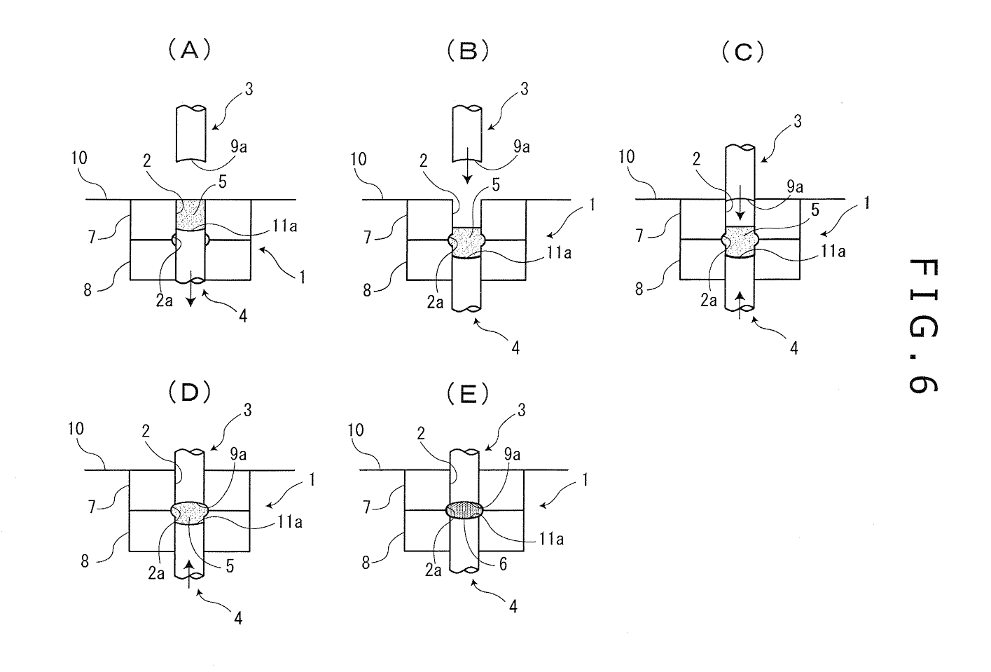

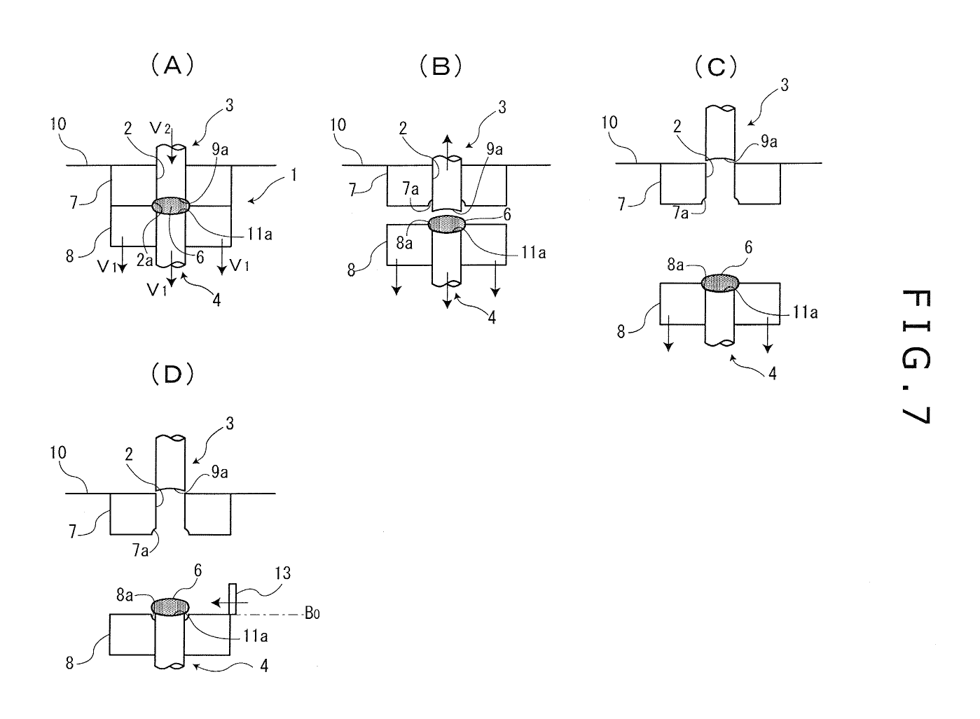

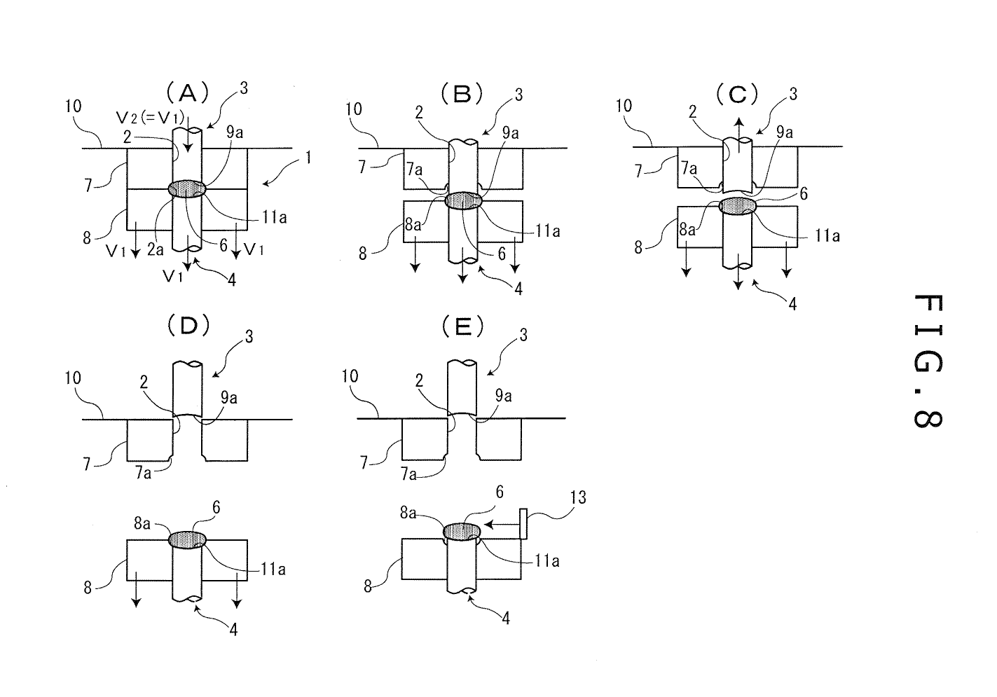

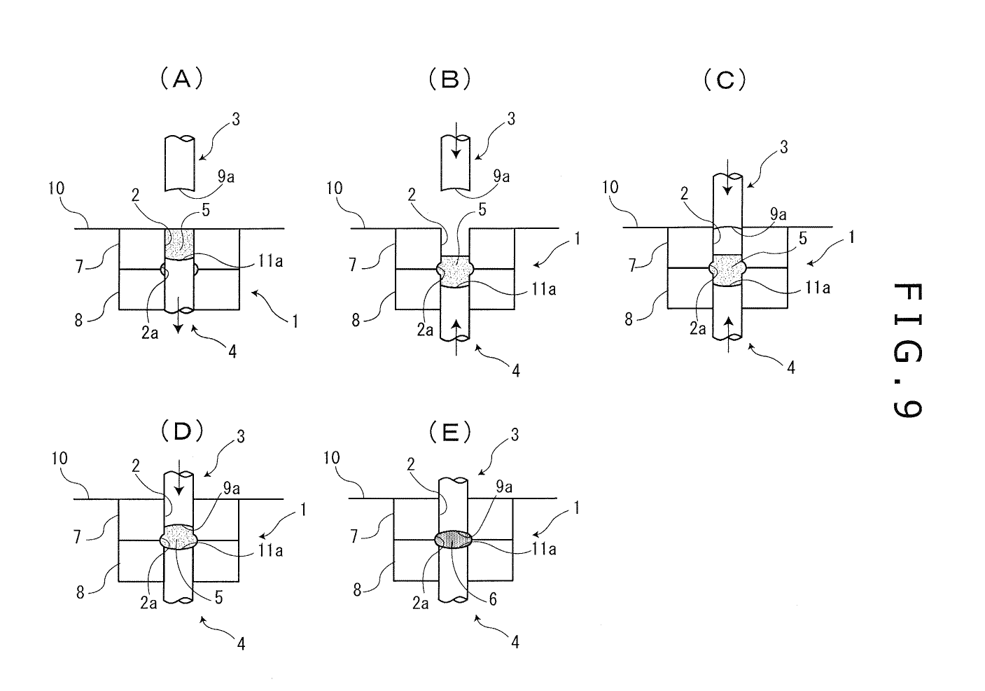

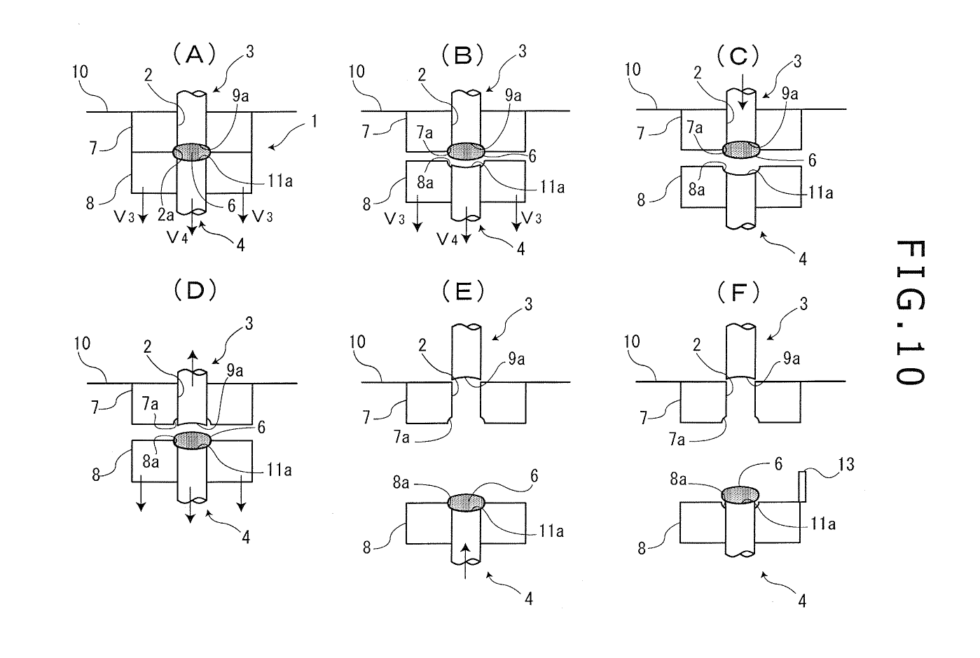

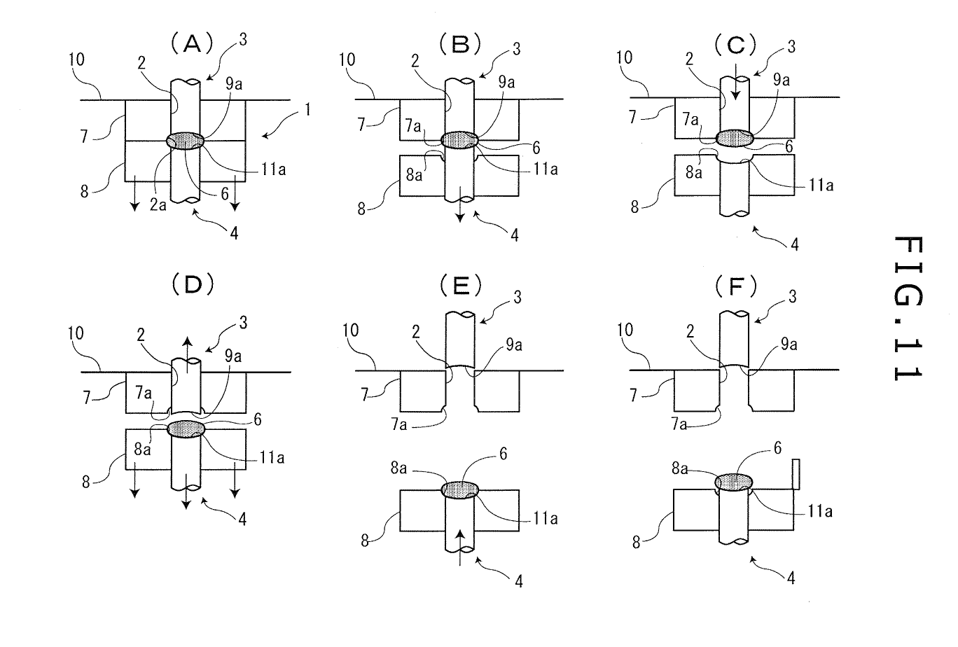

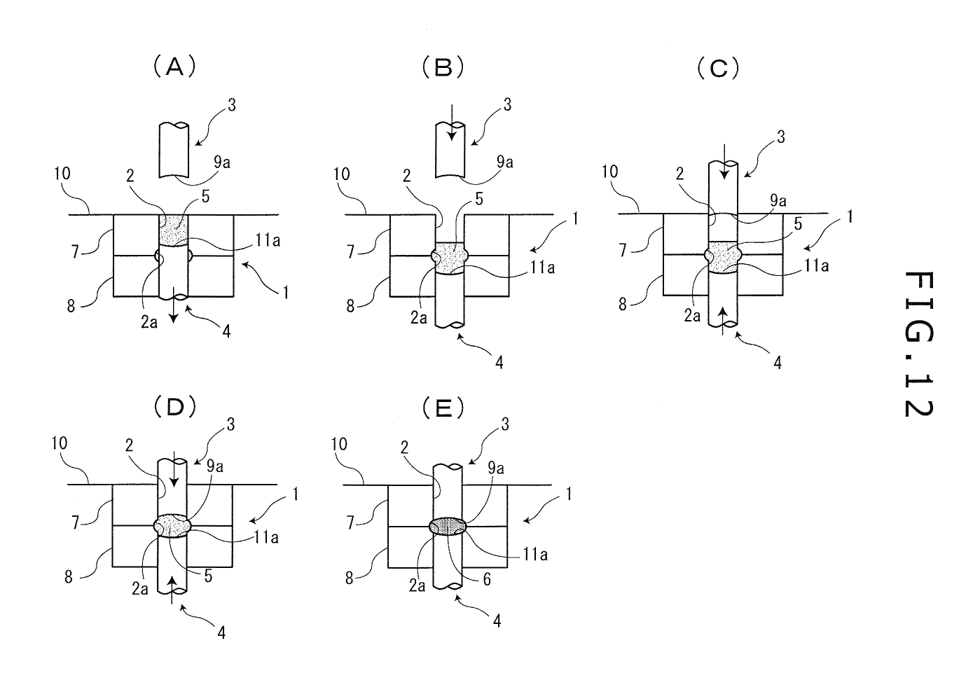

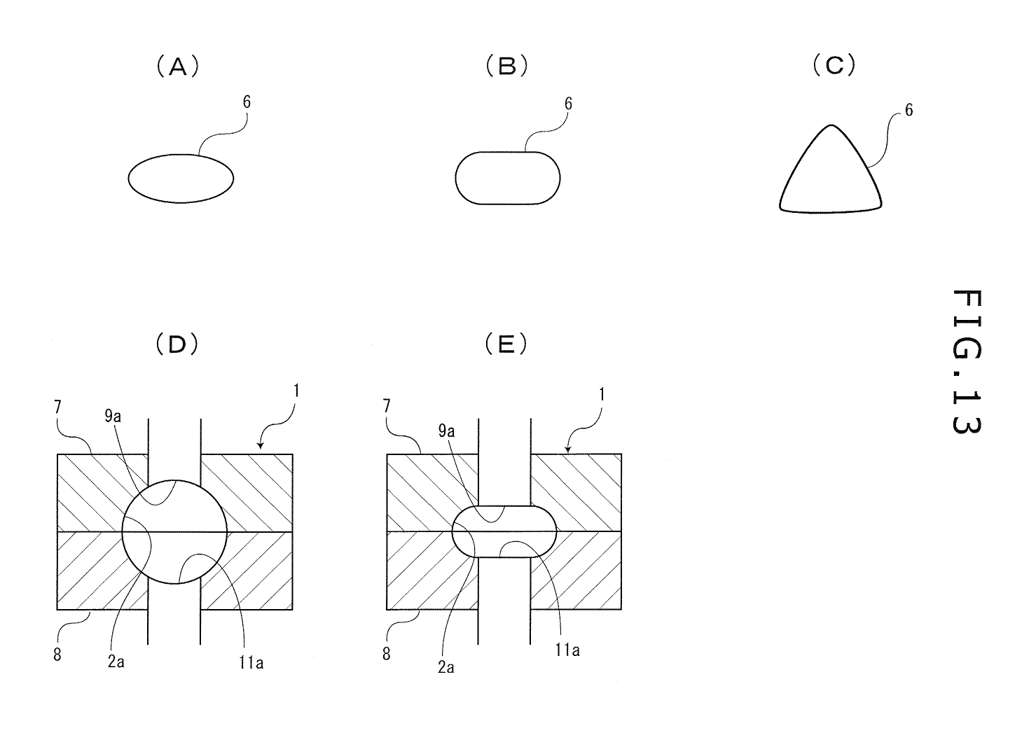

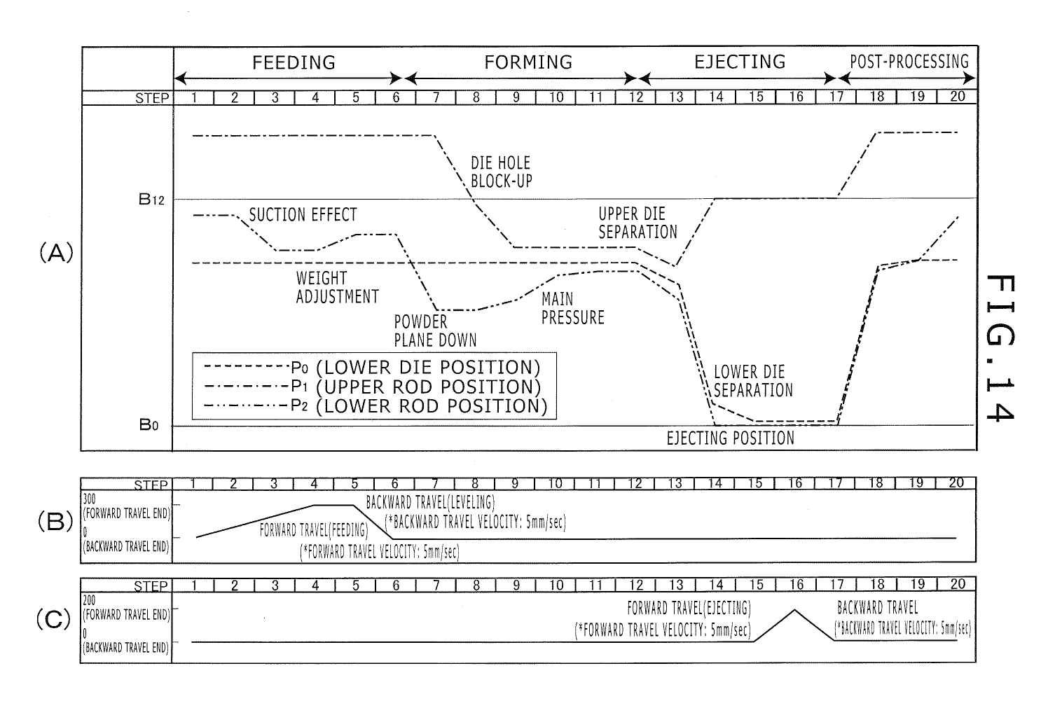

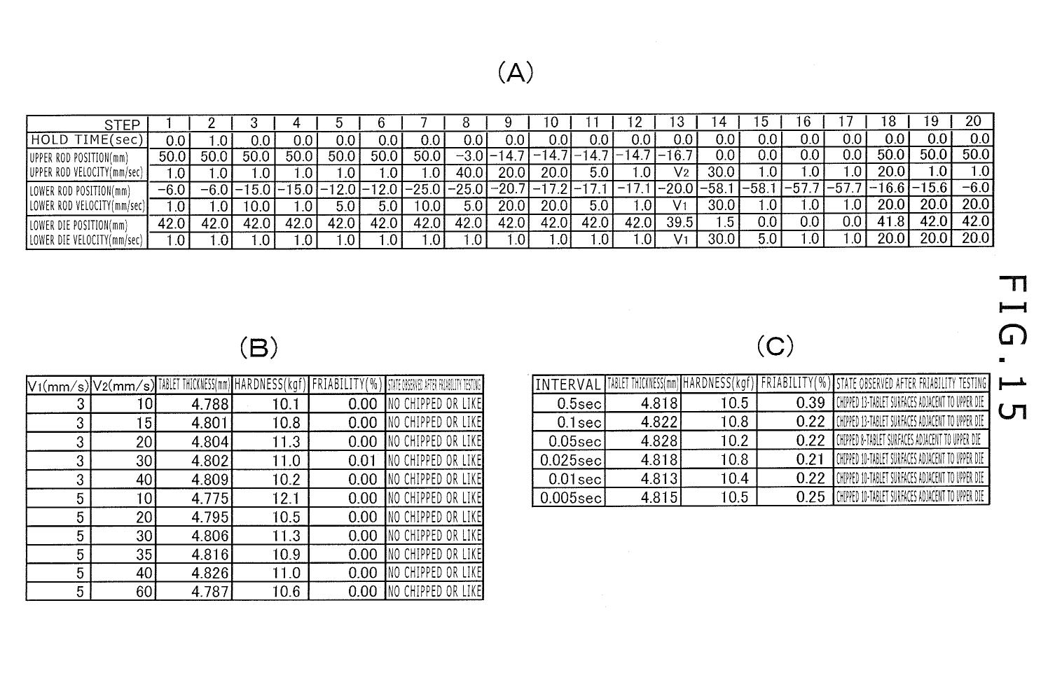

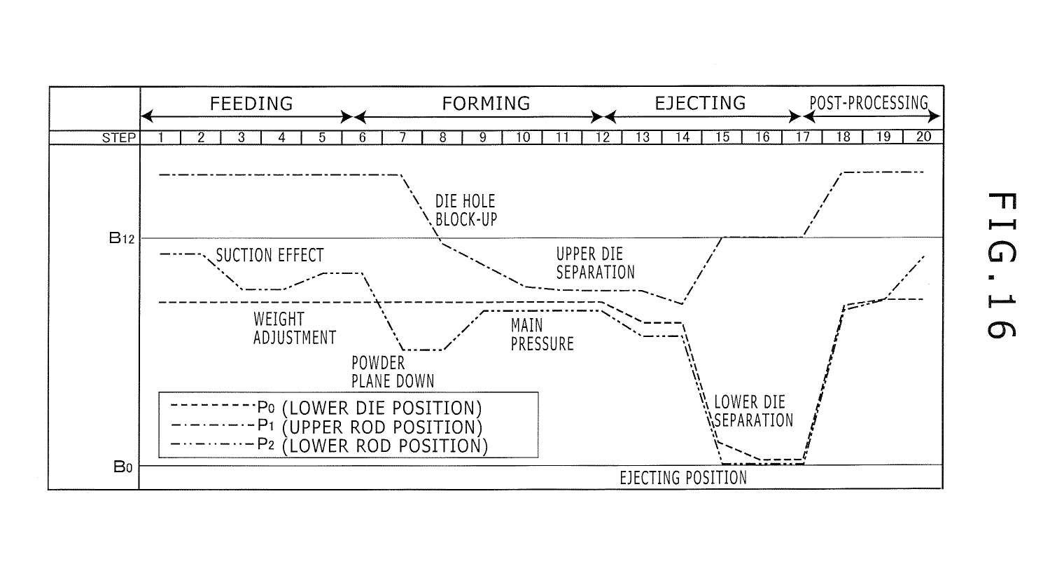

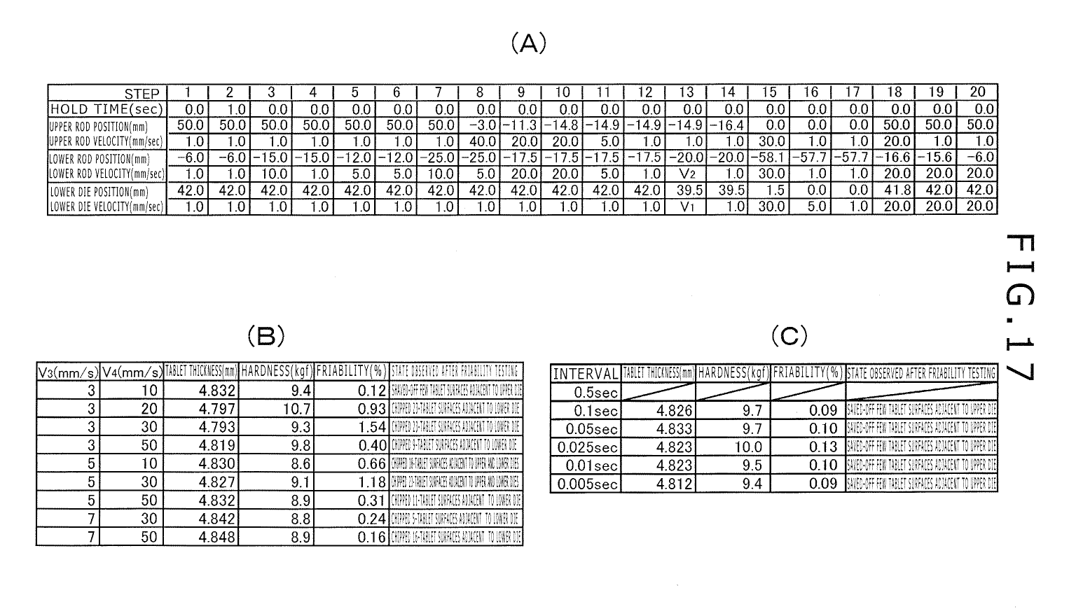

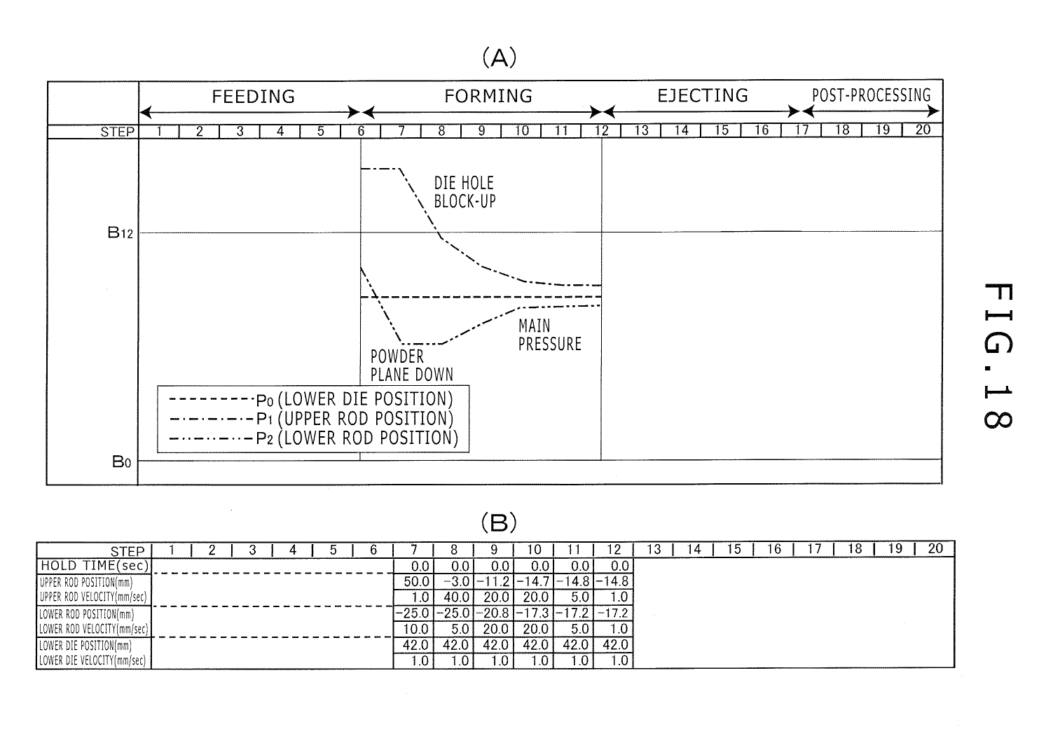

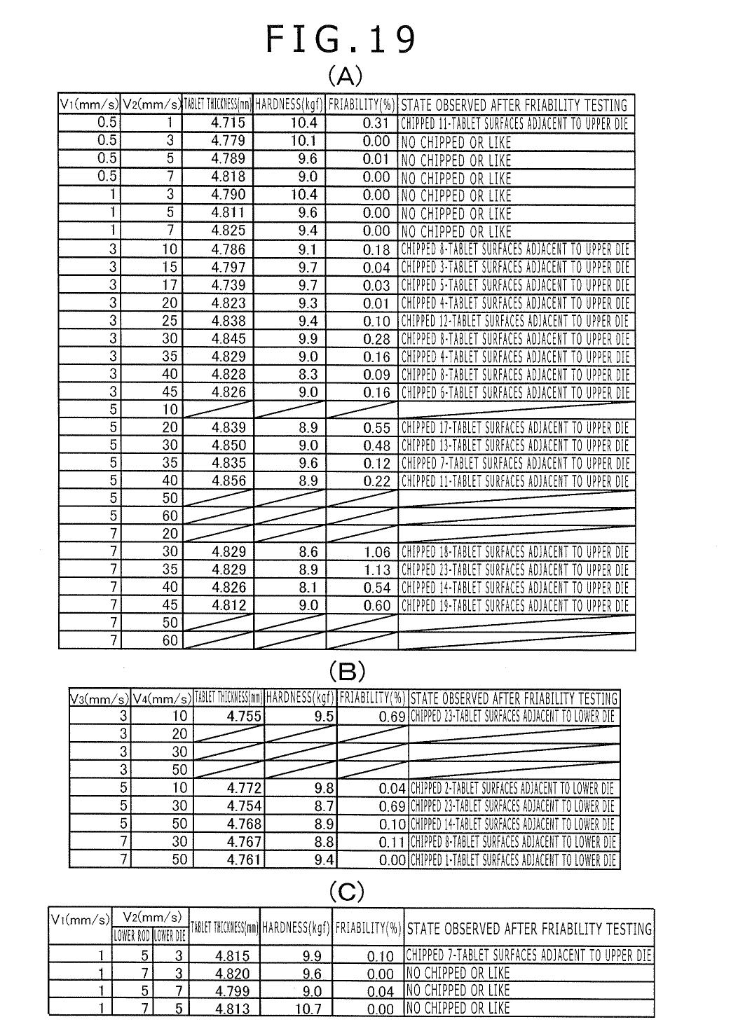

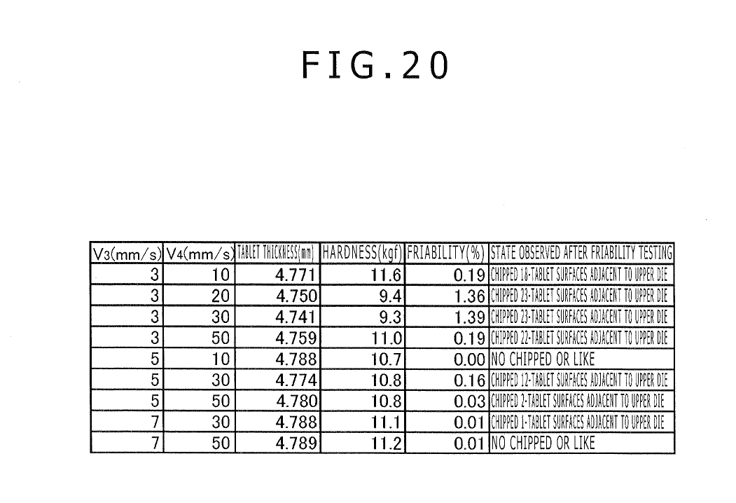

### BRIEF DESCRIPTION OF THE DRAWINGS

[FIG. 1] FIGS. 1(A) and 1(B) are a side view and a plan view respectively showing essential parts of a tablet manufacturing apparatus.

[FIG. 2] FIG. 2(A) is a side view showing essential parts of the tablet manufacturing apparatus at the time when a tablet is press-formed, and FIG. 2(B) is a side view showing essential parts of the tablet manufacturing apparatus at the time when an upper die and a lower die are separated.

[FIG. 3] FIGS. 3(A) and 3(B) are a side view and a plan view respectively showing a press-formed tablet.

[FIG. 4] FIG. 4 shows a flow of processes applied to cases where the tablet is manufactured using the tablet manufacturing apparatus of the present invention.

[FIG. 5] FIGS. 5(A) to 5(D) are side views respectively showing in time series one arrangement of a feeding process.

[FIG. 6]FIGS. 6(A) to 6(E) are side views respectively showing in time series one arrangement of a forming process.

[FIG. 7] FIGS. 7(A) to 7(D) are side views respectively showing in time series one arrangement of an ejecting process.

[FIG. 8] FIGS. 8(A) to 8(E) are side views respectively showing in time series one arrangement of a modification of the ejecting process shown in FIG. 7.

[FIG. 9] FIGS. 9(A) to 9(E) are side views respectively showing in time series one arrangement of another embodiment of the forming process.

[FIG. 10] FIGS. 10(A) to 10(F) are side views respectively showing in time series one arrangement of another embodiment of the ejecting process.

[FIG. 11] FIGS. 11(A) to 11(F) are side views respectively showing in time series one arrangement of a modification of the ejecting process shown in FIG. 10.

[FIG. 12]FIGS. 12(A) to 12(E) are side views respectively showing in time series one arrangement of a further embodiment of the forming process.

[FIG. 13] FIGS. 13(A) to 13(C) are plan views respectively showing different forms of the tablet, and FIGS. 13(D) and 13(E) are sectional side views of essential parts of tablet presses in which there are shown different forms of the forming grooves and those of the upper and lower pushing surfaces.

[FIG. 14] FIG. 14(A) is a timing chart showing the positional relation among the upper rod, the lower rod and the lower die for each action in the case of application of tablet manufacturing shown in FIGS. 4 to 7, FIG. 14(B) is a timing chart showing the position of a feeder for each action in the case of application of tablet manufacturing shown in FIGS. 4 to 7, and FIG. 14(C) is a timing chart showing the position of an ejector for each action in the case of application of tablet manufacturing shown in FIGS. 4 to 7.

[FIG. 15] FIG. 15(A) is a table listing the position and the velocity of each of the upper rod, the lower rod and the lower die for each action in the case of application of tablet manufacturing shown in FIGS. 4 to 7, FIG. 15(B) is a table listing the results of tablet thickness, hardness, friability and state observed, where a separating velocity and a moving velocity have undergone variations in the case of application of tablet manufacturing shown in FIG. 15(A), and FIG. 15(C) is a table listing the results of tablet thickness, hardness, friability and state observed after friability testing in the case of experiments for comparison.

[FIG. 16] FIG. 16 is a timing chart showing the positional relation among the upper rod, the lower rod and the lower die for each action in the case of application of tablet manufacturing shown in FIGS. 9 and 10.

[FIG. 17] FIG. 17(A) is a table listing the position and the velocity of each of the upper rod, the lower rod and the lower die for each action in the case of application of tablet manufacturing shown in FIGS. 9 and 10, FIG. 17(B) is a table listing the results of tablet thickness, hardness, friability and state observed after friability testing, where the separating velocity and the moving velocity have undergone variations in the case of application of tablet manufacturing shown in FIG. 17(A), and FIG. 17(C) is a table listing the results of tablet thickness, hardness, friability and state observed after friability testing in the case of experiments for comparison.

[FIG. 18] FIG. 18(A) is a timing chart showing the positional relation among the upper rod, the lower rod and the lower die for each action in the case of application of tablet manufacturing shown in FIG. 12, and FIG. 18(B) is a table listing the position and the velocity of each of the upper rod, the lower rod and the lower die in the case of application of tablet manufacturing shown in FIG. 18(A).

[FIG. 19] FIG. 19(A) is a table listing the testing and measurement results of tablet thickness, hardness, friability and state observed after friability testing, where the separating velocity and the moving velocity have undergone variations in the case of application of the ejecting process shown in FIG. 7 as well as of tablet manufacturing shown in FIG. 18, FIG. 19(B) is a table listing the testing and measurement results of tablet thickness, hardness, friability and state observed after friability testing, where the separating velocity and the moving velocity have undergone variations in the case of application of the ejecting process shown in FIG. 10 as well as of tablet manufacturing shown in FIG. 18, and FIG. 19(C) is a table listing the results of tablet thickness, hardness, friability and state observed after friability testing in the case of experiments for comparison.

[FIG. 20] FIG. 20 is a table listing the results of tablet thickness, hardness, friability and state observed after friability testing, where the separating velocity and the moving velocity have undergone variations in the case of experiment 1 for comparison.

### MODE FOR EMBODYING THE INVENTION

FIGS. 1(A) and 1(B) are a side view and a plan view respectively showing essential parts of a tablet manufacturing apparatus. FIG. 2(A) is a side view showing essential parts of the tablet manufacturing apparatus at the time when a tablet is press-formed, and FIG. 2(B) is a side view showing essential parts of the tablet manufacturing apparatus at the time when an upper rod and a lower rod are separated. FIGS. 3(A) and 3(B) are a side view and a plan view respectively showing a press-formed tablet. The illustrated tablet manufacturing apparatus is a kind of tablet press and has a horizontal die 1, a vertical hole 2 formed in the die 1 and a pair of upper and lower rods 3 and 4 fittingly inserted into the die hole 2 so that they may be free to be removed therefrom.

For the tablet manufacturing apparatus of this type, the arrangement is such that with the lower rod 4 or a bottom-side rod inserted from its upper end (its end) side into the die hole 2 to block up the die hole 2 at its lower end, powder 5 (see FIGS. 5 to 7) is so fed into the die hole 2 as to be filled therein, and afterwards, the upper rod 3 or a top-side rod is inserted from its lower end (its end) side into the die hole 2 to press the thus filled powder 5 in the die hole 2 with the ends of the upper and lower rods 3 and 4 so that a tablet 6 is press-formed.

The die hole 2 is of a circular form as viewed in plan and has in its vertical center concave forming grooves 2a in the form of an annular concavity all over its circumferential direction. The forming grooves 2a take the form of a circular ring as viewed in cross sectional plan and are indented in the form of concavity outwards in the radial direction of the die hole 2 as viewed in cross sectional side. Thus, the forming groove 2a is supposed to have a bottom portion of a larger diameter R₁ than a diameter R₂ of other portion of the die hole 2 than the forming grooves 2a thereof.

The die 1 may be divided into upper and lower separable pieces at a horizontal plane M of division or a plane passing along the bottom portions of the forming grooves 2a, which upper and lower separable pieces respectively form an upper die 7 and a lower die 8. The upper die 7 is fixed to the main body 10, and the lower die 8 is supported movably upward and downward, which arrangement thus allows the upper and lower dies 7 and 8 to be joined or separated by means of contact or out-of-contact between the confronting surfaces of the upper and lower dies 7 and 8. More specifically, when the lower die 8 is moved up until an upper end position (a lower die position) P₀ of the lower die 8 coincides with a lower end position (a joining position) X₀ of the upper die fixed in position, the upper die 7 and the lower die 8 may be joined together.

The upper and lower rods 3 and 4 have end portions 9 and 11, each of which is of a larger diameter than a diameter of other portion of each of the rods 3 and 4 than the end thereof and is also approximately equal with a diameter R₂ of other portion of the die hole 2 than the forming grooves 2a thereof. Thus, when the upper and lower rods 3 and 4 are respectively inserted into the die hole 2, the outer circumferences of the above end portions 9 and 11 will be conditioned that they are fitted to the inner circumference of the die hole 2. The lower end of the end portion 9 and the upper end of the end portion 11 respectively form concave pushing surfaces 9a and 11a.

For press-forming the tablet 6, the upper die 7 and the lower die 8 are joined together to pressingly insert the upper rod 3 into the die hole 2 until a lower end position (an upper rod position) P₁ of the outer circumference of the upper rod 3 coincides with an upper end position (an upper press-forming position, a press-forming position) X₁ of the forming groove 2a, and also to pressingly insert the lower rod 4 into the die hole 2 until an upper end position (a lower rod position) P₂ of the outer circumference of the lower rod 4 coincides with a lower end position (a lower press-forming position, a press-forming position) X₂ of the forming groove 2a. By so doing, the forming grooves 2a will be integrally linked to the upper and lower pushing surfaces 9a and 11a in a smooth manner into a circular, elliptical or oval form (an elliptical form for the illustrated embodiment) as viewed in cross sectional side, so that the tablet 6 of the same form may be press-formed (see FIG. 2(A)).

The thus press-formed tablet 6 takes a circular form having the approximately same diameter as the diameter R₁ of the forming groove 2a as viewed in plan and is elliptical as viewed in side. Because of the larger diameter R₁ of the tablet 6 than the diameter R₂ of other portion of the die hole 2 than the forming grooves 2a thereof, the tablet 6 will be held in the forming grooves 2a. The thus held tablet 6 may be taken out of the die by separating the joined upper and lower dies 7 and 8 to open the upper side of the tablet 6.

Next will be described a tablet manufacturing method using the tablet manufacturing apparatus with reference to FIGS. 4 to 7.

FIG. 4 shows a flow of processes applied to cases where the tablet is manufactured using the tablet manufacturing apparatus of the present invention. The tablet manufacturing method shown in FIG. 4 comprises a feeding process S10 of feeding the powder 5 into the die hole 2, a forming process S20 of press-forming the tablet 6 out of the fed powder 5 in the die hole 2, an ejecting process S30 of ejecting the press-formed tablet 6 and a post-processing process S40 of making post-processing.

FIGS. 5(A) to 5(D) are side views respectively showing in time series one arrangement of the feeding process. As shown in FIGS. 5(A) to 5(D) and also in FIG. 4, the above feeding process S10 includes steps of feeding S11 of feeding the powder 5 into the die hole 2, adjusting S12 of adjusting the amount of powder 5 in the die hole 2 after feeding and leveling S13 of leveling off the powder 5, which is pushed outwards out of the die hole 2, along the upper surface of the upper die 7 after adjusting.

With the step of feeding S11, manufacturing of the tablet 6 is started, in which case, when started, the lower die 8 (the lower die position P₀) is in the joining position X₀ at which it is joined with the upper die 1, the upper rod 3 (the upper rod position P₁) is in a topmost position (an initial position) above the upper die 7, and the lower rod 4 (the lower rod position P₂) is in a position (an initial position) above the forming grooves 2a in the die hole 2. Under the above positional conditions, a feeder 12 called a filling feeder is driven for forward travel from its backward travel end to its forward travel end to push the powder 5 forwards so that the powder will be fed into the die hole 2 by means of being dropped. On occasions when the powder 5 is fed by means of being dropped, the lower rod 4 is lowered to a stop position at which the powder 5 may be brought in the die hole 2 smoothly (see FIGS. 5(A) and 5(B)).

In the step of adjusting S12, the lower rod 4 is moved up until it reaches a position (an adjusting position) above the forming grooves 2a in the die hole 2, at which position the powder 5 is pushed outwards above the die hole 2, so that only the required amount of powder 5 for tablet forming will be conditioned to be in the die hole 2 (see FIGS. 5(B) and 5(C)).

In the step of leveling S13, the feeder 12 is driven for backward travel from its forward travel end to its backward travel end to level off the powder 5 by its portion pushed outwards out of the die hole 2 in order to allow only the required amount of powder 5 for forming the tablet 6 to remain in the die 1 (see FIGS. 5(C) and 5(D)).

FIGS. 6(A) to 6(E) are side views respectively showing in time series one arrangement of the forming process. As shown in FIGS. 6(A) to 6(E) and also in FIG. 4, the above forming process S20 includes steps of prearranging S21 of making pre-arrangements for press-forming and pressing S22 of press-forming the tablet 6 after the prearranging S21.

In the step of prearranging S21, the lower rod 4 is lowered until it reaches a position (a prearranging position) below the forming grooves 2a in the die hole 2 in order to allow the powder plane at the upper end of the powder 5 to be located below the upper surface of the upper die 7 (see FIGS. 6(A) and 6(B)). Afterwards, the upper rod 3 is lowered until it reaches an upper end position (a block-up position) in the die hole 2 in order to block up the upper side of the die hole 2 (see FIGS. 6(B) and 6(C)).

Subsequently, the upper rod 3 is lowered to the upper press-forming position X₁, while the lower rod 4 is moved up until it reaches a position (a preliminary pressing position) neighboring the lower side of the forming grooves 2a in the die hole 2 in order to allow a space between the upper and lower pushing surfaces 9a and 11a in the die hole 2 to be filled with the powder 5 (see FIGS. 6(C) and 6(D)).

In the step of pressing S22, the upper rod 3 is made fixed or approximately fixed to the die 1 by stopping driving for movement to bring positioning to a stop, under which condition, the lower rod 4 is pressingly moved up to the lower press-forming position X₂ to press-form the tablet 6 (see FIGS. 6(D) and 6(E)). More specifically, the present embodiment is such that the upper rod 3 forms a final fixed rod (a final pressed rod) pressed in fixed or approximately fixed position from its side adjacent to the lower rod 4 at the time when the tablet 6 is press-formed, the lower rod 4 forms a final pressing rod adapted to apply pressure (main pressure) to the powder 5 at the time when the tablet 6 is press-formed, the upper die 7 forms a final fixed separable piece (a pressed separable piece) adjacent to the final fixed rod, and the lower die 8 forms a final pressing separable piece adjacent to the final pressing rod.

FIGS. 7(A) to 7(D) are side views respectively showing in time series one arrangement of the ejecting process. As shown in FIGS. 7(A) to 7 (D) and also in FIG. 4, the above ejecting process S30 includes steps of taking-out S31 of taking the tablet 6 out of the pushing surface 9a of at least one of the upper and lower rods 3 and 4 or the upper rod 3, as well as taking the tablet 6 out of an upper curved surface 7a of the upper die 7 or a curved surface forming the upper half of the forming groove 2a and also out of a lower curved surface 8a of the lower die 8 or a curved surface forming the lower half of the forming groove 2a, and ejecting S32 of ejecting the tablet 6 from the pushing surface 11a of the lower rod 4 after the taking-oat S31.

In the step of taking-out S31, a lowering action of the lower rod 4 and the lower die 8 so as to be separated from the upper die 7 and a lowering action of the upper rod 3 so as to be moved toward the lower rod 4 are firstly started at the same time (see FIGS. 7(A) and 7(B)). At this point in time, a separating velocity V₁ at which the lower rod 4 and the lower die 8 are separated from the upper die 7 and a moving velocity V₂ at which the upper rod 3 is moved toward the lower rod 4 are of approximately fixed, in which case, the moving velocity V₂ is set at a value lower than the separating velocity V₁.

The lowering action of the upper rod 3 results in that the upper rod 3 gets out of position nearer to the lower rod 4 with respect to the upper die 7, which arrangement thus allows the tablet 6 to be taken out of the upper curved surface 7a of the upper die 7. Besides, because of the moving velocity V₂ set at a value lower than the separating velocity V₁, spacing between the upper rod 3 and the lower rod 4 increases, which arrangement thus allows the tablet 6 to be taken out of the pushing surface 9a of the upper rod 3.

That is, there is provided a difference between the separating velocity V₁ and the moving velocity V₂ in order to allow the tablet 6 to be taken out of the upper curved surface 7a of the upper die 7 and also out of the pushing surface 9a of the upper rod 3 speedily almost without any time lag through a single action which is a simultaneous lowering action of the upper rod 4, the lower rod 4 and the lower die 8.

Subsequently, the lower rod 4 and the lower die 8 are integrally lowered at the same velocity until the lower rod 4 reaches a lowermost position (an ejecting position) thereof, while the upper rod 3 is moved up until it reaches an upper end position (a refuge position) of the die hole 2 (see FIGS. 7(B) and 7(C)). Afterwards, only the lower die 8 is lowered to a lowermost position (an ejecting position) thereof (see FIGS.7(C) and 7(D)). At this point in time, the lower rod 4 gets out of position nearer to the upper rod 3 with respect to the lower die 8, which arrangement thus allows the tablet 6 to be taken out of the lower curved surface 8a of the lower die 8.

In the step of ejecting S32, an ejector 13 called an ejecting damper which functions as a scraper is driven for forward travel from its backward travel end to its forward travel end to eject the tablet 6 from the pushing surface 11a of the lower rod 4 by scraping, followed by being driven for backward travel to its backward travel end (see FIG. 7(D)).

As shown in FIG. 4, the above post-processing process S40 includes a step of post-processing S41 of returning the upper and lower rods 3 and 4 and the lower die 8 to their initial positions in order to bring the processes to an end.

According to the thus arranged tablet manufacturing method of the present invention, it will be appreciated that the tablet 6 is taken out of the final fixed rod 3 and the final fixed separable piece 7 opposite to the final pressing rod 4 and the final pressing separable piece 8, and subsequently out of the final pressing separable piece 8, so that efficient release from the stress developed in the tablet 6 in process of press-forming may be attained, which arrangement thus allows the tablet 6 of high quality to be manufactured.

In particular, as described the above, the tablet 6 is taken out of the final fixed rod 3 at the approximately same time that the tablet 6 is taken out of the final fixed separable piece 7, which arrangement thus allows the tablet 6 to be taken out of the die 1 in such a manner as to minimize the effect of the residual wall stress developed in the tablet 6 at its surface adjacent to the forming grooves 2a in process of press-forming.

FIGS. 8(A) to 8(E) are side views respectively showing in time series one arrangement of a modification of the ejecting process shown in FIG. 7. The ejecting process S30 shown in FIG. 8 includes a step of taking-out S31 in which the lowering action of the lower rod 4 and the lower die 8 is started at the same time as the lowering action of the upper rod 3 in order to take the tablet 6 out of the upper die 7 and the upper rod 3, in which case, the above separating velocity V₁ is set at the same value as the moving velocity V₂, wherein the tablet 6 is firstly taken out of the upper die 7 (see FIGS. 8(A) and 8(B)), and thereafter, only the lower rod 4 and the lower die 8 are separated from the upper die 3 at the same velocity so that spacing between the upper rod 3 and the lower rod 4 increases, which arrangement thus allows the tablet 6 to be taken out of the upper rod 3 (see FIGS. 8(B) and 8 (C)). That is, the process of taking the tablet 6 out of the upper die 7 and the process of taking the tablet 6 out of the upper rod 3 are supposed to take separate actions. It is noted that other actions are the same as those shown in FIG. 7.

Next will be described different points on another embodiment of the tablet manufacturing method from the above embodiment thereof with reference to FIGS. 9 and 10.

FIGS. 9(A) to 9(E) are side views respectively showing in time series one arrangement of another embodiment of the forming process. The forming process S20 shown in FIG. 9 is different from that shown in FIG. 6 in procedure to be taken after the upper rod 3 is lowered to the block-up position to block up the upper side of the die hole 2. More specifically, after that, the lower rod 4 is moved up to the lower press-forming position X₂, while the upper rod 3 is lowered until it reaches a position (a pre-pressing position) neighboring the upper side of the forming grooves 2a in the die hole 2 in order to allow the space between the upper and lower pushing surfaces 9a and 11a in the die hole 2 to be filled with the powder 5 (see FIGS. 9(C) and 9(D)).

In the step of pressing S22, the lower rod 4 is made fixed or approximately fixed to the die 1 by stopping driving for movement to bring positioning to a stop, under which condition, the upper rod 3 is pressingly lowered to the upper press-forming position X₁ to press-form the tablet 6 (FIGS. 9(D) and 9(E)). More specifically, the illustrated another embodiment is such that the lower rod 4 forms the final fixed rod (the final pressed rod) pressed in fixed or approximately fixed position from its side adjacent to the upper rod 3 at the time when the tablet 6 is press-formed, the upper rod 3 forms the final pressing rod adapted to apply pressure (main pressure) to the powder 5 at the time when the tablet 6 is press-formed, the lower die 8 forms the final fixed separable piece (the final pressed separable piece) adjacent to the final fixed rod, and the upper die 7 forms the final pressing separable piece adjacent to the final pressing rod.

FIGS. 10(A) to 10(F) are side views respectively showing in time series one arrangement of another embodiment of the ejecting process. The ejecting process S30 shown in FIG. 10 is different in taking-out process contents from that in the embodiment and the modification shown in FIGS. 7 and 8. That is, the illustrated ejecting process S30 includes a step of taking-out S31 in which the tablet 6 is taken out of the pushing surfaces 9a and 11a of the upper and lower rods 3 and 4 as well as the tablet 6 is taken out of the lower curved surface 8a of the lower die 8 or the curved surface forming the lower half of the forming groove 2a and also out of the upper curved surface 7a of the upper die 7 or the curved surface forming the upper half of the forming groove 2a, and the subsequent processes are the same as those shown in FIG. 7.

In the step of taking-out S31 of the illustrated another embodiment, the lowering action of the lower die 8 so as to be separated from the upper die 7 is started at the same time as the lowering action of the lower rod 4 so as to be moved in the direction away from the upper rod 3 (see FIGS. 7(A) to 7(C)). At this point in time, a separating velocity V₃ at which the lower die 8 is separated from the upper die 7 and a moving velocity V₄ at which the lower rod 4 is moved in the direction away from the upper rod 3 are of approximately fixed, in which case, the moving velocity is set at a value lower than the separating velocity V₃.

Because of the moving velocity V₄ set at a value lower than the separating velocity V₃ as described the above, the lower rod 4 gets out of position nearer to the upper rod 3 with respect to the lower die 8, which arrangement thus allows the tablet 6 to be taken out of the lower curved surface 8a of the lower die 7. Besides, the lowering action of the lower rod 4 results in that spacing between the upper rod 3 and the lower rod 4 increases, which arrangement thus allows the tablet 6 to be taken out of the pushing surface 11a of the lower rod 4. That is, there is provided a difference between the separating velocity V₃ and the moving velocity V₄ in order to allow the tablet 6 to be taken out of the lower curved surface 8a of the lower die 8 and also out of the pushing surface 11a of the lower rod 4 speedily almost without any time lag through a single action which is a simultaneous lowering action of the lower rod 4 and the lower die 8.

Subsequently, the upper rod 3 is moved to a position (a pushing position) neighboring the lower side of the upper press-forming position X₁ to displace the upper rod 3 toward the lower rod 4 with respect to the upper die 7, at which position the tablet 6 is taken out of the upper curved surface 7a of the upper die 7, followed by being dropped onto the pushing surface 11a of the lower rod 4 (see FIGS. 10(C) and 10(D)).

Subsequently, the lower rod 4 and the lower die 8 are integrally lowered at the same velocity until the lower rod 4 reaches the ejecting position, while the upper rod 3 is moved up to a refuge position thereof (see FIGS. 10(D) and 10(E)), After that, the lower die 8 is lowered to the ejecting position B₀ (see FIGS. 10(E) and 10(F)) like the embodiment and modification shown in FIGS. 7 and 8, and the subsequent process is the same as that in the above embodiment and modification.

FIGS. 11(A) to 11(F) are side views respectively showing in time series one arrangement of a modification of the ejecting process shown in FIG. 10. The ejecting process S30 shown in FIG. 11 includes a step of taking-out S31 in which the tablet 6 is taken out of the lower die 8 and the lower rod 4 in such a manner that only the lower die 8 is firstly lowered to take the tablet 6 out of the lower die 8 (see FIGS. 11(A) and (B)), and thereafter, only the lower rod 4 is moved in the direction away from the upper rod 3 to increase spacing between the upper rod 3 and the lower rod 4 in order to take the tablet 6 out of the lower rod 4 (see FIGS. 11(B) and 11(C)). That is, the process of taking the tablet 6 out of the lower die 8 and the process of taking the tablet 6 out of the lower rod 4 are supposed to take separate actions. It is noted that other actions are the same as those shown in FIG. 10.

Next will be described different points on a further embodiment of the tablet manufacturing method from the above embodiments thereof with reference to FIG. 12.

FIGS. 12(A) to 12(E) are side views respectively showing in time series one arrangement of a further embodiment of the forming process. The forming process S20 shown in FIG. 12 is different from that shown in FIG. 6 in procedure to foe taken after the upper rod 3 is lowered to the block-up position to block up the upper side of the die hole 2. More specifically, after that, the upper rod 3 is lowered to the pre-pressing position neighboring the upper side of the forming grooves 2a, while the lower rod 4 is moved up to the pre-pressing position neighboring the lower side of the forming grooves 2a in order to allow the space between the upper and lower pushing surfaces 9a and 11a in the die hole 2 to be filled with the powder 5 (see FIGS. 12(C) and 12(D)). At this point in time, spacing between the upper pre-pressing position and the upper press-forming position X₁ will be approximately the same as spacing between the lower pre-pressing position and the lower press-forming position X₂.

In the step of pressing S22, the pressingly lowering action of the upper rod 3 to the upper press-forming position X₁ and the pressingly moving-up action of the lower rod 4 to the upper press-forming position X₂ are started at the same time and at the same velocity to press-form the tablet 6 with the upper and lower rods 3 and 4 (see FIGS. 12(D) and 12(E)). That, is, the illustrated further embodiment is such that both the upper rod 3 and the lower rod 4 form the final pressing rods adapted to apply pressure (main pressure) to the powder 5 at the time when the tablet 6 is press-formed, and both the upper die 7 and the lower die 8 form the final pressing separable pieces.

Further, the ejecting process S30 to be taken may be any one of the ejecting processes respectively shown in FIGS. 7, 8, 10 and 11.

Next will be described another embodiment of the tablet manufacturing apparatus with reference to FIG. 13.

FIGS. 13(A) to 13(C) are plan views respectively showing different forms of the tablet, and FIGS. 13(D) and 13(E) are sectional side views of essential parts of tablet presses in which there are shown different forms of the forming grooves and those of the upper and lower pushing surfaces. Having been described the above embodiment as related to one instance where a tablet 6 is press-formed in the circular form as viewed in plan, it is to be understood that it would be possible also to form the die hole 2 and the forming grooves 2a into an elliptical form as viewed in plan in order to press-form the tablet 6 of an elliptical form as viewed in plan (see FIG. 13(A)), or into an oval form (a round-cornered rectangular form) as viewed in plan in order to press-form the tablet 6 of an oval form as viewed in plan (see FIG. 13(B)), or into a rounded triangular form (a triangular rice ball-like form) as viewed in plan in order to press-form the tablet 6 of a triangular rice ball-like form as viewed in plan (see FIG. 13(C)).

It would be possible also to modify the curvature of the forming grooves 2a and that of the pushing surfaces 9a and 11a so that the forming grooves 2a and the pushing surfaces 9a and 11a will be integrally linked together into a circular form as viewed in side at the time when press-forming of the tablet 6 is completed, instead of the above-described elliptical form as viewed in side (see FIG. 13(D)). Alternatively, it would be possible also to form the pushing surfaces 9a and 11a in a flat form, together with modification of the curvature of the forming grooves 2a so that the forming grooves 2a and the pushing surfaces 9a and 11a will be integrally linked together into an oval form as viewed in side at the time when press-forming of the tablet 6 is completed (see FIG. 13(E)).

### EXAMPLE 1

Next will be described one specific example of the tablet manufacturing method shown in FIGS. 4 to 7 with reference to FIGS. 14 and 15.

Firstly was produced the powder 5, which was then used to manufacture the tablet 6 according to the tablet manufacturing method shown in FIGS. 4 to 7, and then, measurements on tablet thickness of the thus manufactured tablet 6 were made together with hardness testing and friability testing thereof to evaluate the tablet manufacturing method.

Referring first to how to produce the powder 5, 4950 g of acetaminophen as an effective component, 3310 g of lactose as a vehicle, 3150 g of macrocrystalline cellulose as a vehicle likewise and 900 g of hydroxypropyl-cellulose as a binder for binding the particles of materials together were respectively weighed (exactly measured) and then mixed together in a polyethylene bag, and afterwards, the resultant mixture was pulverized in a screen size of 0.7 mm using a crusher (YARIYA-type crusher No. 1 manufactured by YARIYA MACHINERY MFG CO.). The thus pulverised substance was divided into three lots, and into a granulator (a vertical granulator FM-VG-25 manufactured by POWREX CORPORATION) was put 4000 g of the thus divided lot of the pulverised substance, to which 720 g of pure water was added for granulation.

Subsequently, the resultant granulated substance was dried using a drier (a flow granulation drier FD-3S manufactured by POWREX CORPORATION), and the thus dried substance was then classified using a 22-mesh sieve into the sieved substance and the remainder which is the residue on the sieve. The processes similar to the above were taken also for the remaining divided lots of the pulverized substance, while the remainder as the residue on the sieve was pulverised in a screen size of 1.0 mm using a pulverizer (a new speed mill ND-10S manufactured by OKADA SEISAKUSHO INC.) and then mixed with the above sieved substance to form the granulated substance. 11680 g of the thus granulated substance and 64 g of magnesium stearate as a lubricant added to increase the fluidity of granules for facilitated press-forming were put into a mixer (V-type mixer V-60 manufactured by TOKUJU CORPORATION) and then mixed together for five minutes into the mixture in the form of granules (the powder 5) for tablet pressing.

It is noted that the tablet 6 is press-formed out of 290 mg of the thus produced powder 5, in which case, it is supposed that 290 mg of the powder 5 be conditioned to contain 116 mg of acetaminophen, 77.5 g of lactose, 21.1 mg of microcrystalline cellulose, 73.8 mg of hydroxypropyl-cellulose and 1.6 mg of magnesium stearate.

In cases where the tablet 6 shown in FIG. 3 is press-formed out of the thus produced powder 5, the diameter (the diameter of a circle which is the form of the tablet 6 as viewed in plan) R₂ of the tablet 6 is set at 9 mm, and the thickness (the maximum vertical thickness of the tablet 6 as viewed in side) d thereof (see FIG. 3) is set in the range of 4.7 to 4.9 mm. It is noted that the upper and lower press-forming positions X₁ and X₂ are invariable, whereas the above separating velocities V₁ and V₃ and the above moving velocities V₂ and V₄ are varied as described later, so that dilatation at the time when the tablet 6 is taken out is supposed to vary, and it will thus result in that the tablet thickness d is not of completely fixed.

Referring now to the measurements on the tablet thickness, the hardness testing and the friability testing, the measurements on the tablet thickness d were made using a micrometer (a click micro MDQ-30M manufactured by MITUTOYO CORPORATION).

The hardness testing employs a tablet hardness tester (a SCHLEUNIGER tablet hardness tester 8M manufactured by SCHLEUNIGER CORPORATION) having a pair of clamping structures for clamping the tablet 6 from a direction orthogonal to a tablet thickness direction and is for measurements on the hardness (unit of which is kgf) of the tablet 6 using the above tablet hardness tester based on clamping force of the clamping structures at the time when breakage of the tablet 6 occurs by gradually increasing the above clamping force until the tablet 6 is broken into fragments. It is noted that the Japanese Pharmacopoeia contains prescription of more detailed information on the above hardness testing.

The friability testing is of a testing method prescribed by the JP, US and EP Pharmacopoeia (see F-131 to 134 of a document titled by “The Japanese Pharmacopoeia Manual, Fifteenth” edited by the Japanese Pharmacopoeia Manual Edit Committee, the first edition thereof was issued from HIROKAWA SHOTEN COMPANY on Jun. 20, 2006) for making measurements on the friable property of the edge surface of the tablet 6 due to impact thereon. For the present example, the friability testing was made using a friability tester (a friability tester PTF30ERA manufactured by JAPAN MACHINERY COMPANY).

To be brief, a laterally cylindrical-shaped resin-made drum having a predetermined diameter is supported so that it may be driven for rotation about an axis, and into the drum are put 23 pieces of press-formed tablets 6. The drum is driven in this condition for rotation at a predetermined speed of rotation to turn the tablets 6 downwards repeatedly through the medium of a radially intermediate plate integrally rotated within the drum. Then, after the lapse of predetermined time, the tablets 6 are taken out of the drum, and fragments thereof are cleared off to find a value obtained by dividing a difference between the total weight later than testing and that previous to testing by the total weight previous to testing, which value is regarded as friability (unit of which is %), which friability closer to zero has such meaning that there may be produced satisfactory results. It is noted that the present example involves state observations on the tablets 6 later than friability testing as well.

Referring now to the tablet manufacturing method, in cases where the above powder 5 is used to press-form the tablet 6, the diameter (the diameter of other portion of the die hole 2 than the forming grooves 2a thereof) R₂ of each of the end portions 9 and 11 of the upper and lower rods 3 and 4 is set at 7 mm.

FIG. 14(A) is a timing chart showing the positional relation among the upper rod, the lower rod and the lower die for each action in the case of application of tablet manufacturing shown in FIGS. 4 to 7. FIG. 14(B) is a timing chart showing the position of the feeder for each action in the case of application of tablet manufacturing shown in FIGS. 4 to 7. FIG. 14(C) is a timing chart showing the position of the ejector for each action in the case of application of tablet manufacturing shown in FIGS. 4 to 7. FIG. 15(A) is a table listing the position and the velocity of each of the upper rod, the lower rod and the lower die for each action in the case of application of tablet manufacturing shown in FIGS. 4 to 7. FIG. 15(B) is a table listing the results of tablet thickness, hardness, friability and state observed, where the separating velocity and the moving velocity have undergone variations in the case of application of tablet manufacturing shown in FIG. 15(A). FIG. 15(C) is a table listing the results of tablet thickness, hardness, friability and state observed after friability testing in the case of experiments for comparison.

Referring to these FIGURES, the upper rod position P₁ and the lower rod position P₂ indicate heights from a reference position B₁₂ on the assumption that the upper end position of the upper die 7 be the reference position B₁₂ (see FIG. 1(A)). Thus, these upper and lower rod positions, when being below the reference position B₁₂, are supposed to take minus values, and when being above the reference position B₁₂, are supposed to take plus values. Meanwhile, the lower die position P₀ indicates a height from the ejecting position B₀, and besides, as to the velocity of each of the lower die 8, the upper rod 3 and the lower rod 4, it is indicated only by a velocity value irrespective of their up and down movements. It is noted that the ejecting position B₀ is 57.7 mm down apart from the reference position B₀.

The results of the experiments having been made by bringing each part into operation as shown in FIGS. 14 and 15 according to the procedure shown in FIGS. 4 to 7 are the friability of approximately 0% or values close thereto, the tablet thickness d and the hardness of approximately fixed, and no observation of any chipped tablet surface portion or the like in each tablet 6 in the case of the separating velocity V₁ and the moving velocity V₂ both having been set at any value.

Meanwhile, for the experiments for comparison as shown in FIG. 15(C), the tablets were manufactured according to one modification shown in FIG. 8. Referring to a column of intervals listed in the table shown in FIG. 15(C), there are shown times taken from when the lowering action (the previous step) of the upper rod 3, the lower rod 4 and the lower die 8 at the same velocity is completed until the lowering action (the subsequent step) of the lower rod 4 and the lower die 8 at the same velocity is started (see FIGS. 6(A) and 8(B)), in which case, the lowering velocity and the lowering distance of each of the upper rod 3, the lower rod 4 and the lower die 8 at the time of the previous step are respectively the same as those of each of the lower rod 4 and the lower die 8 at the time of the subsequent step, where the lowering velocity and the lowering distance for intervals of 0.5 seconds are respectively set at 1 mm/sec. and 0.5 mm (that is, the lowering distance of each of the lower rod 4 and the lower die 8 in the previous step and that thereof in the successive step sum up to 1 mm), those for intervals of 0.1 seconds are respectively set at 5 mm/sec. and 0.5 mm, those for intervals of 0.05 seconds are respectively set at 10 mm/sec and 0.5 mm, those for intervals of 0.025 seconds are respectively set at 20 mm/sec. and 0.5 mm, those for intervals of 0.01 seconds are respectively set at 50 mm/sec. and 0.5 mm, and those for intervals of 0.05 seconds are respectively set at 100 mm/sec. and 0.5 mm. Other actions of the upper and lower rods 3 and 4 and the lower die 8 are the same as those shown in FIGS. 14 and 15(A).

According to the above experiments for comparison, it is seen that the friability is of higher values as compared with that in the above results, and the chipped tablet surface portion adjacent to the upper die 7 is observed in about the half of tablets 6 after friability testing, in which case, however, the tablet hardness is of approximately fixed, and the press-formed tablets 6 of a certain degree of quality are observed.

### EXAMPLE 2

Next will be described one specific example of the tablet manufacturing method shown in FIGS. 9 and 10 with reference to FIGS. 16 and 17, where how to produce the powder 5, the size (the diameter R₁ and the tablet thickness d) of the tablet 6 to be formed, the evaluations on the tablet 6 and the action timing of each of the feeder 12 and the ejector 13 are made equal to those in the above Example 1.

FIG. 16 is a timing chart showing the positional relation among the upper rod, the lower rod and the lower die for each action in the case of application of tablet manufacturing shown in FIGS. 9 and 10. FIG. 17(A) is table listing the position and the velocity of each of the upper rod, the lower rod and the lower die for each action in the case of application of tablet manufacturing shown in FIGS. 9 and 10. FIG. 17(B) is a table listing the results of tablet thickness, hardness, friability and state observed after friability testing, where the separating velocity and the moving velocity have undergone variations in the case of application of tablet manufacturing shown in FIG. 17(A). FIG. 17(C) is a table listing the results of tablet thickness, hardness, friability and state observed after friability testing in the case of experiments for comparison.

The results of experiments having been made by bringing each part into operation as shown in FIGS. 16 and 17 according to the procedure shown in FIGS. 9 and 10 are the variation in friability in the range as wide as from 0.12 to 1.54%, and the observation of the chipped tablet surface portion at the opposite sides or adjacent to the lower die in the number of tablets 6 as many as 5 to 23 pieces in the case of the separating velocity V₃ and the moving velocity V₄ each having undergone variations as shown in FIG. 17(B). However, which experiments result in success in press-forming the tablet 6 for the present.

Meanwhile, for the experiments for comparison shown in FIG. 17(C), the tablets were manufactured according to one modification shown in FIG. 11. Referring to a column of intervals listed in the table shown in FIG. 17(C), there are shown times taken from when the lowering action (the previous step) of the lower die 8 is completed until the lowering action (the subsequent step) of the lower rod 4 is started (see FIGS. 11(A) to 11(C)), in which case, the lowering velocity and the lowering distance of the lower die 8 at the time of the previous step are respectively the same as those of the lower rod 4 at the time of the subsequent step, where the lowering velocity and the lowering distance for intervals of 0.5 seconds are respectively set at 1 mm/sec. and 0.5 mm, those for intervals of 0.1 seconds are respectively set at 5 mm/sec. and 0.5 mm, those for intervals of 0.05 seconds are respectively set at 10 mm/sec. and 0.5 mm, those for intervals of 0.025 seconds are respectively set at 20 mm/sec. and 0.5 mm, those for intervals of 0.01 seconds are respectively set at 50 mm/sec. and 0.5 mm, and those for intervals of 0.005 seconds are respectively set at 100 mm/sec. and 0.5 mm. Other actions of the upper and lower rods 3 and 4 and the lower die 8 are the same as those shown in FIGS. 16 and 17(A).

According to the above experiments for comparison, it is seen that the friability is limited to a lower value, whereas the long intervals (of 0.5 seconds for the above table) result in a failure to form the tablets 6 in some cases.

### EXAMPLE 3

Next will be described one specific example of the tablet manufacturing method shown in FIG. 12 with reference to FIGS. 18 and 19, wherein how to produce the powder 5, the size (the diameter R₁ and the tablet thickness d) of the tablet 6 to be formed, the evaluations on the tablet 8 and the action timing of each of the feeder 12 and the ejector 13 are made equal to those in the above Examples 1 and 2.

FIG. 18(A) is a timing chart showing the positional relation among the upper rod, the lower rod and the lower die for each action in the case of application of tablet manufacturing shown in FIG. 12. FIG. 18(B) is a table listing the position and the velocity of each of the upper rod, the lower rod and the lower die for each action in the case of application of tablet manufacturing shown in FIG. 18(A). For the tablet manufacturing method according to this example, in the ejecting process S30 were taken the procedure shown in FIG. 7 (more specifically, the same procedure as that from step 13 to step 17 shown in FIG. 14(A), except that the upper rod position P₁ in step 13 is set at −16.8 mm) and the procedure shown in FIG. 10 (more specifically, the same procedure as that from step 13 to step 17 shown in FIG. 16, except that the upper rod position P₁ in step 13 is set at −14.8 mm).

FIG. 19(A) is a table listing the testing and measurement results of the tablet thickness, hardness, friability and state observed after friability testing, where the separating velocity and the moving velocity have undergone variations in the case of application of the ejection process shown in FIG. 7 as well as of tablet manufacturing shown in FIG. 7. FIG. 19(B) is a table listing the testing and measurement results of the tablet thickness, hardness, friability and state observed after friability testing, where the separating velocity and moving velocity have undergone variations in the case of application of the ejection process shown in FIG. 10 as well as of tablet manufacturing shown in FIG. 18. FIG. 19(C) is a table listing the results of tablet thickness, hardness, friability and state observed after friability testing in the case of experiments for comparison.

The results of experiments shown in FIG. 19(A) are the variations in friability in the range as wide as from 0.00 to 1.13%, in number of tablets 6 having the chipped tablet surface portion on the opposite sides or adjacent to the lower die in the range as wide as 0 to 23 pieces, and in hardness and tablet thickness d in the wider range as compared with the above examples with the variations in separating velocity V₁ and moving velocity V₂, which experiments result in a failure to press-form the tablet 6 in some cases depending on the combination of the separating velocity V₃ with the moving velocity V₄ in some cases.

The results of experiments shown in FIG. 10(B) show the same tendency as those shown in FIG. 19(A), which experiments results in a failure to press-form the tablet 6 in some cases depending on the combination of the separating velocity V₃ with the moving velocity V₄.

Meanwhile, for the experiments for comparison shown in FIG. 19(C), when varying the moving velocities V₂ of the lower rod 4 and the lower die 8 in the case of the experiments shown in FIG. 19(A), the lower rod 4 and the lower die 8 were set to be different in moving velocity. The results thereof are also the friability as low as that the chipped tablet surface portion or the like adjacent to the lower die 8 was observed in several pieces of tablets 6, which experiment thus produced the satisfactory results in most parts.

### EXAMPLE 4

For comparison with the results in Examples 1 to 3, experiments 1 to 4 for comparison were made under the conditions that an experiment on tablet manufacturing by application of the forming process S20 shown in FIG. 6 (more specifically, the same procedure as that from step 7 to step 12 shown in FIG. 15(A)) in combination with the ejecting process S30 shown in FIG. 10 (more specifically, the same procedure as that from step 13 to step 17 shown in FIG. 17(A) except that the upper rod position P₁ in step 13 is set at −14.7 mm) be given as an experiment 1 for comparison, that on tablet manufacturing by application of the forming process S20 shown in FIG. 6 in combination with the ejecting process S30 shown in FIG. 11 (more specifically, the ejecting process S30 in the experiment for comparison in Example 2) be given as an experiment 2 for comparison, that on tablet manufacturing by application of the forming process S20 shown in FIG. 9 (more specifically, the same procedure as that from step 7 to step 12 shown in FIG. 16) in combination with the ejecting process S30 shown in FIG. 7 (more specifically, the same procedure as that from step 13 to step 17 shown in FIG. 15(A) except that the upper rod position P₁ in step 13 is set at −16.7 mm) be given as an experiment 3 for comparison, and that on tablet manufacturing by application of the forming process S20 shown in FIG. 9 in combination with the ejecting process S30 shown in FIG. 8 (more specifically, the ejecting process in the experiment for comparison in Example 1) be given as an experiment 4 for comparison.

It is noted that how to produce the powder 5, the size (the diameter R₁ and the tablet thickness d) of the tablet 6 to be formed, the evaluations on the tablet 6, the action timing of each of the feeder 12 and the elector 13, the feeding process S10 and the post-processing process S40 are made equal to those in the above Examples 1 to 3.

FIG. 20 is a table listing the results of tablet thickness, hardness, friability and state observed after friability testing, where the separating velocity and the moving velocity have undergone variations in the case of the experiment 1 for comparison. It is seen that the experiments 2 to 4 for comparison result in a failure to form the tablet 6 into a normal form even in all cases where the separating velocity V₁ and the moving velocity V₂ have undergone variations, while the experiment 1 for comparison results in success in press-forming the tablets 6 for the present. However, it is seen that the results of these experiments 1 to 4 for comparison are, in general, of being unsatisfactory as compared with those of the above examples.

### EXPLANATION OF REFERENCE NUMERALS

1: Die

2: Die hole

2a: Forming groove

3: Upper rod (Rod, final fixed ponder, final pressed rod and final pressing rod)

4: Lower rod (Rod, final fixed rod, final pressed rod and final pressing rod)

5: Powder

6: tablet

7: Upper die (Separable piece, final fixed separable piece, final pressed separable piece and final pressing separable piece)

8: Lower die (Separable piece, final fixed separable piece, final pressed separable piece and final pressing separable piece)

9a: Pushing surface

11a: Pushing surface

V₁, V₃: Separating velocity

V₂, V₄: Moving velocity

X₁: Upper press-forming position (Press-forming position)

X₂: Lower press-forming position (Press-forming position)

1. A tablet manufacturing method in which an upper rod (3) and a lower rod (4) are fittingly inserted into a vertical hole (2) formed in a die (1) to press powder (5) in the die hole (2) with a pushing surface (9a) at the lower end of the upper rod (3) and a pushing surface (11a) at the upper end of the lower rod (4) in order to press-form a tablet (6), characterized in that concave forming grooves (2a) integrally linked to the upper and lower pushing surfaces (9a) and (11a) are formed annularly in the inner circumferential surface of the die hole (2), and the die may be divided into an upper separable piece (7) and a lower separable piece (8) at the bottom portions of the forming grooves (2a), wherein after a final fixed rod or one of the upper and lower rods (3) and (4) is moved to and then fixed at a press-forming position at which the pushing surface (9a or 11a) is integrally linked to the corresponding forming groove (2a), a final pressing rod or the other rod (3) or (4) is moved to the press-forming position so that the tablet (6) of a circular, elliptical or oval form as viewed in cross sectional side is press-formed, and then, the press-formed tablet (6) held in the forming grooves (2a) is taken out of the die by separating the upper and lower separable pieces (7) and (8), in which case, the tablet (6) after being taken out of a final fixed separable piece or the separable piece (7) or (8) adjacent to the final fixed, rod and also out of the final fixed rod is taken out of the final pressing separable piece or the separable piece (7) or (8) adjacent to the final pressing rod.

2. The tablet manufacturing method according to claim 1, wherein the final fixed rod or the final fixed separable piece is displaced so that the final fixed rod will be out of position nearer to the final pressing rod with respect to the final fixed separable piece in order to take the tablet (6) out of the final fixed separable piece, and the final fixed rod or the final pressing rod is displaced so that the final fixed rod and the final pressing rod will get away from each other in order to take the tablet (6) out of the final fixed rod.

3. The tablet manufacturing method according to claim 1, wherein a separating action of the final pressing rod and the final pressing separable piece from the final fixed separable piece at the same velocity is started at the same time as a moving action of the final fixed rod toward the final pressing rod, in which case, a separating speed at the time of said separating action of the final pressing rod and the final pressing separable piece is set at a value higher than a moving velocity at the time of said moving action of the final fixed rod in order to take the tablet (6) out of the final fixed separable piece and the final fixed rod.

4. The tablet manufacturing method according to claim 3, wherein the lower rod (4) is regarded as the final pressing rod, and the lower separable piece (8) is regarded as the final pressing separable piece.

5. The tablet manufacturing method according to claim 1, wherein a separating action of the final fixed separable piece from the final pressing separable piece is started at the same time as a moving action of the final fixed rod in the direction away from the final pressing rod, in which case, a moving velocity at the time of said moving action of the final fixed rod is set at a value lower than a separating velocity at the time of said separating action of the final fixed separable piece in order to take the tablet (6) out of the final fixed separable piece and the final fixed rod.

6. The tablet manufacturing method according to claim 5, wherein the upper rod (3) is regarded as the final pressing rod, and the upper separable piece (7) is regarded as the final pressing separable piece.

7. The tablet manufacturing method according to claim 2, wherein a separating action of the final pressing rod and the final pressing separable piece from the final fixed separable piece at the same velocity is started at the same time as a moving action of the final fixed rod toward the final pressing rod, in which case, a separating speed at the time of said separating action of the final pressing rod and the final pressing separable piece is set at a value higher than a moving velocity at the time of said moving action of the final fixed rod in order to take the tablet (6) out of the final fixed separable piece and the final fixed rod.

8. The tablet manufacturing method according to claim 7, wherein the lower rod (4) is regarded as the final pressing rod, and the lower separable piece (8) is regarded as the final pressing separable piece.

9. The tablet manufacturing method according to claim 2, wherein a separating action of the final fixed separable piece from the final pressing separable piece is started at the same time as a moving action of the final fixed rod in the direction away from the final pressing rod, in which case, a moving velocity at the time of said moving action of the final fixed rod is set at a value lower than a separating velocity at the time of said separating action of the final fixed separable piece in order to take the tablet (6) out of the final fixed separable piece and the final fixed rod.

10. The tablet manufacturing method according to claim 9, wherein the upper rod (3) is regarded as the final pressing rod, and the upper separable piece (7) is regarded as the final pressing separable piece.
